(19) United States
(12) Patent Application Publication
(10) Pub. No.: US 2026/0220285 A1
(43) Pub. Date: Jul. 30, 2026

(54) OBJECT IDENTIFICATION AND VERIFICATION FOR DIGITAL CONTENT ACCESS CONTROL

(71) Applicant: Peter ANGRITT, New Braunfels, TX (US)

(72) Inventor: Peter ANGRITT, New Braunfels, TX (US)

(21) Appl. No.: 19/039,235

(22) Filed: Jan. 28, 2025

(51) Int. Cl. G06F 21/62; G06T 17/00; G06V 10/70; G06V 30/19

(52) U.S. Cl. CPC G06F 21/6209; G06T 17/00; G06V 10/70; G06V 30/19093; G06V 2201/07

(57) ABSTRACT

This disclosure provides systems, methods, and devices that enable object recognition and digital content access based on image analysis. In one aspect, a method is provided that includes receiving an image from a first computing device, detecting an object within the image, determining a corresponding object record for the object, and providing access to one or more pieces of digital content in response to determining the corresponding object record. Other aspects are also discussed.

### CROSS-REFERENCE TO RELATED APPLICATIONS

The present application claims priority to U.S. patent application Ser. No. 18/507,216, filed on Jan. 29, 2024, the disclosure of which is incorporated herein by reference for all purposes.

### BACKGROUND

Digital content access control may refer to the techniques and systems used to manage and regulate how digital information is accessed. These systems may help prevent unauthorized access, copying, or distribution of digital content, which can be critical for protecting intellectual property and sensitive information.

One common method of managing digital content access may be through the use of Digital Rights Management (DRM) technologies. DRM may encompass a range of tools and protocols designed to restrict how digital content can be used and shared. This may include encryption, licensing agreements, and user authentication processes, which together aim to ensure that only authorized users or devices can access the content.

Other techniques may include the use of access control policies that define specific rules for who can access digital content and under what conditions. Role-based access control (RBAC) may assign permissions based on user roles, making it easier to manage and enforce access rights within an organization. These approaches may work together to create a secure and controlled environment for managing digital content access.

### SUMMARY

The present disclosure describes techniques for object recognition and digital content access using image processing and machine learning. These techniques may involve capturing an image of an object using a first computing device, such as a smartphone or AR/VR headset, and processing the image to detect and identify the object. The object detection may be performed using specialized machine learning models, potentially on the capturing device or a second computing device. The system may extract keywords from the image, compare visual features with a database of verified objects, and potentially use visual data representations like QR codes for identification. Characteristics of the object (e.g., physical dimensions) may also be determined and used for verification. Once the object is successfully identified and matched with a corresponding record in a database, the system may provide access to related digital content, which could include various multimedia formats, interactive experiences, or streaming content.

A first aspect provides a method comprising receiving an image from a first computing device, detecting an object within the image, determining a corresponding object record for the object, and providing access to one or more pieces of digital content in response to determining the corresponding object record.

In a second aspect according to the first aspect, the object is detected using a first machine learning model.

In a third aspect according to the first aspect, the corresponding object record is determined within a database storing a plurality of object records.

In a fourth aspect according to the first aspect, determining a corresponding object record comprises extracting one or more keywords from the image that correspond to the object, and determining the corresponding object record based on the one or more keywords including at least one matching keyword from the corresponding object record.

In a fifth aspect according to any of the first through fourth aspects, the corresponding object record includes one or more images of a verified object, and determining the corresponding object record comprises determining that the object within the image matches the verified object.

In a sixth aspect according to any of the first through fifth aspects, determining the corresponding object record comprises detecting a visual data representation, and determining the corresponding object record based on the visual data representation.

In a seventh aspect according to any of the first through sixth aspects, the method further comprises determining one or more object characteristics of the object, and determining that the corresponding object record was correctly determined based on the one or more object characteristics.

In an eighth aspect according to any of the first through seventh aspects, providing access to the one or more pieces of digital content comprises streaming multimedia content to the computing device.

In a ninth aspect according to any of the first through eighth aspects, receiving an image from a first computing device comprises receiving the image from a virtual reality (VR) headset operating in an augmented reality (AR) or VR setting.

A tenth aspect provides a system comprising a processor and a memory storing instructions which, when executed by the processor, cause the processor to perform operations including receiving an image from a first computing device, detecting an object within the image, determining a corresponding object record for the object, and providing access to one or more pieces of digital content in response to determining the corresponding object record.

In an eleventh aspect according to the tenth aspect, the operations further include detecting the object using a first machine learning model.

In a twelfth aspect according to the tenth aspect, the corresponding object record is determined within a database storing a plurality of object records.

In a thirteenth aspect according to the tenth aspect, determining a corresponding object record comprises extracting one or more keywords from the image that correspond to the object, and determining the corresponding object record based on the one or more keywords including at least one matching keyword from the corresponding object record.

In a fourteenth aspect according to any of the tenth through thirteenth aspects, the corresponding object record includes one or more images of a verified object, and determining the corresponding object record comprises determining that the object within the image matches the verified object.

In a fifteenth aspect according to any of the tenth through fourteenth aspects, determining the corresponding object record comprises detecting a visual data representation, and determining the corresponding object record based on the visual data representation.

In a sixteenth aspect according to any of the tenth through fifteenth aspects, the operations further include determining one or more object characteristics of the object, and determining that the corresponding object record was correctly determined based on the one or more object characteristics.

In a seventeenth aspect according to any of the tenth through sixteenth aspects, providing access to the one or more pieces of digital content comprises streaming multimedia content to the computing device.

In an eighteenth aspect according to any of the tenth through seventeenth aspects, receiving an image from a first computing device comprises receiving the image from a virtual reality (VR) headset operating in an augmented reality (AR) or VR setting.

A nineteenth aspect provides a non-transitory, computer-readable medium storing instructions which, when executed by a processor, cause the processor to perform operations comprising receiving an image from a first computing device, detecting an object within the image, determining a corresponding object record for the object, and providing access to one or more pieces of digital content in response to determining the corresponding object record.

In a twentieth aspect according to the nineteenth aspect, the corresponding object record includes one or more images of a verified object, and determining the corresponding object record comprises determining that the object within the image matches the verified object.

The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the disclosed subject matter.

### BRIEF DESCRIPTION OF THE FIGURES

FIG. 1 illustrates a system for object identification and verification for digital content access control according to one aspect of the present disclosure.

FIG. 2 illustrates a method for object identification and verification for digital content access control according to one aspect of the present disclosure.

FIG. 3 illustrates a computing device according to one aspect of the present disclosure.

### DETAILED DESCRIPTION OF EXAMPLE EMBODIMENTS

Existing techniques for accessing digital content often rely on manual input methods, such as typing keywords or scanning specific codes. These methods may be time-consuming, error-prone, and limited in their ability to provide contextual and interactive experiences. Traditional content access systems may also struggle with authenticating physical objects and verifying user rights, potentially leading to unauthorized access or distribution of digital assets.

Another problem with existing techniques may be the lack of seamless integration between physical objects and digital experiences, particularly in augmented and virtual reality environments. This disconnection may limit the potential for immersive and interactive content delivery tied to real-world items.

One solution to these problems may be to use object recognition to control and verify digital content access rights. This system may utilize advanced image processing and machine learning techniques to accurately identify objects from captured images. The described techniques may employ a multi-faceted approach to object identification, which may combine visual feature matching, keyword extraction, and dimensional verification. This comprehensive method may enhance accuracy and reduce false positives in object recognition. Additionally, the system may incorporate various authentication mechanisms, such as checking against a database of verified objects or using embedded visual data representations, which may help in detecting counterfeit items and ensuring the integrity of content access.

Furthermore, the present techniques may enable seamless integration between physical objects and digital content, particularly in AR/VR environments. By allowing for real-time object recognition and immediate content access, these techniques may create more immersive and interactive experiences tied to physical items.

In some aspects, the present disclosure provides techniques for object recognition and digital content access that may be particularly beneficial in enhancing user experiences and streamlining content distribution. For example, the described system may offer a more intuitive and efficient way for users to access digital content related to physical objects. Instead of manually searching for or inputting information, users may simply capture an image of an object to instantly access relevant multimedia content, potentially saving time and reducing errors.

The multi-device architecture described in these techniques may improve the overall performance and versatility of the system. By allowing for distributed processing between user devices and servers, the system may optimize resource usage and potentially provide faster response times. This architecture may also enable the system to handle a wide range of object types and content formats, adapting to various use cases and user needs.

Moreover, the advanced object authentication methods incorporated in these techniques may enhance security and digital rights management. By verifying the authenticity of physical objects before granting access to digital content, the system may help protect against unauthorized content distribution and may support new models of content monetization tied to physical products.

In the context of AR and VR applications, the described techniques may significantly enhance immersive experiences. The ability to seamlessly recognize real-world objects and integrate them with digital content in real-time may open up new possibilities for interactive storytelling, education, and entertainment.

Lastly, the flexibility and scalability of the described system may provide benefits for content creators and distributors. The ability to easily associate digital content with physical objects and manage access through a centralized database may streamline content management and distribution processes, reducing costs and expanding reach.

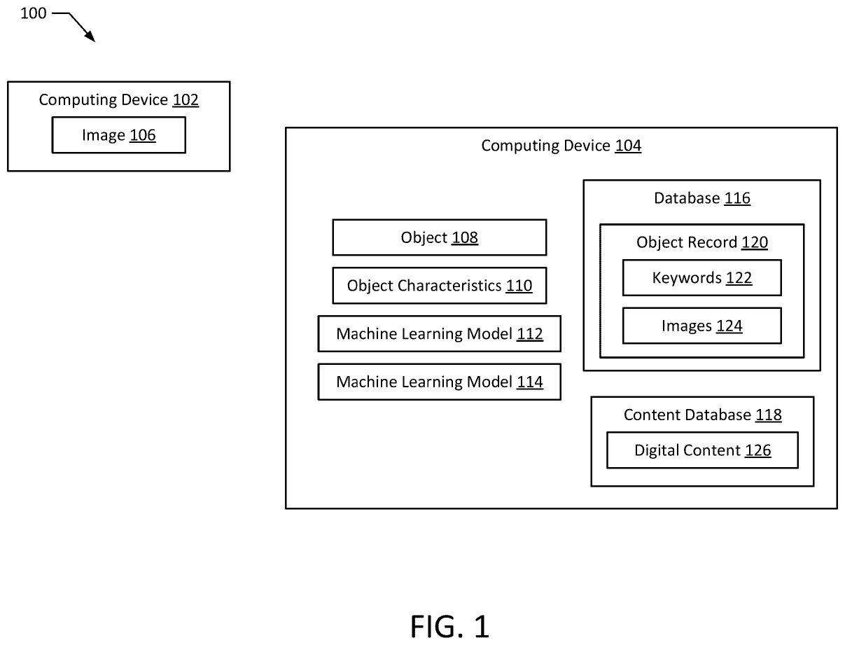

FIG. 1 illustrates a system 100 for object identification and verification for digital content access control according to one aspect of the present disclosure. The system 100 includes a first computing device 102 and a second computing device 104. The first computing device 102 includes an image 106. The second computing device 104 includes an object 108, object characteristics 110, a first machine learning model 112, a second machine learning model 114, a database 116, and a content database 118. The database 116 includes a corresponding object record 120, which includes keywords 122 and images 124. The content database 118 includes digital content 126.

The second computing device 104 and/or the first computing device 102 may be configured to receive an image 106 from the first computing device 102. In certain implementations, the first computing device 102 may include a variety of devices capable of capturing and transmitting images, such as a smartphone, tablet, laptop computer, desktop computer, or dedicated imaging device. In some implementations, the first computing device 102 may include a virtual reality (VR) headset or augmented reality (AR) device operating in an AR or VR setting, allowing for image capture and transmission within immersive environments. In such settings, the object 108 may be a virtual object rendered within the environment, and the system may detect and identify the object based on user interactions, selections, or predefined virtual coordinates. In certain implementations, the image 106 may be received and processed at least in part by the same computing device that captured it (e.g., the first computing device 102). For example, a smartphone may capture an image 106 of an object and then perform at least a subset of the processing discussed below, such as object detection, keyword extraction, or preliminary matching against a local database, before optionally transmitting the results or the processed image to a server for further analysis or verification.

In additional or alternative implementations, the image 106 may be received by another computing device, such as the second computing device 104. In certain such implementations, the second computing device 104 may include a variety of devices such as dedicated image processing servers, cloud-based artificial intelligence platforms, edge computing devices, or specialized hardware accelerators designed for machine learning tasks. For instance, the second computing device 104 may be implemented a high-performance server cluster optimized for real-time image analysis and object recognition, a distributed network of edge devices strategically positioned to minimize latency in AR/VR environments, and the like. In certain implementations, the second computing device 104 may include one or more advanced GPUs or TPUs (Tensor Processing Units) to handle the computational demands of object detection and matching models, as well as high-speed storage systems for rapid database queries. In certain implementations, the second computing device 104 may be configured to utilize load balancing mechanisms to efficiently manage high volumes of incoming image requests, ensuring scalability and consistent performance.

In certain implementations, the image 106 can be captured in various contexts depending on the user's intent and the device's capabilities. For example, a single image 106 may be captured specifically to request access to digital content 126, such as when a user captures an image of a movie poster to gain access to related multimedia content. Alternatively, the image 106 may be part of a continuous stream of image frames captured in a live feed or preview mode of the computing device. For instance, in an AR application, the computing device 102, 104 may regularly receive and process image frames from the video feed of a camera, detecting and recognizing objects in real-time. Such continuous analysis may allow for seamless integration of digital content 126 with the physical world, such as overlaying animated characters on specific real-world objects or providing instant access to digital content when recognized objects enter the device's field of view. Alternatively, the system may receive other forms of input, such as audio signals from voice commands or melodies, tactile inputs from touch-sensitive devices, or inputs from virtual reality environments. For example, a user may verbally request access to digital content by speaking a specific phrase or melody, which the system analyzes to identify the corresponding object record 120. In certain implementations, users with visual impairments may interact with objects through tactile inputs on specialized devices, which detect patterns or shapes touched by the user and process these inputs to identify the object 108. In virtual or augmented reality settings, users may interact with virtual objects or controls to request access to digital content 126. Such alternative input modalities expand the accessibility and applicability of the system to a wider range of users and environments.

The second computing device 104 may be configured to detect an object 108 within the image 106. In certain implementations, the object 108 may be detected using a first machine learning model 112. In certain implementations, the object 108 may be detected using a first machine learning model 112. In certain implementations, object detection may be performed by a specialized machine learning model, such as a convolutional neural network (CNN) or a region-based convolutional neural network (R-CNN), configured to detect one or more predetermined types of objects 108. For example, the first machine learning model 112 may be trained on a diverse dataset of images containing various objects like posters, book covers, clothing items, or 3D objects, enabling the first machine learning model 102 to accurately identify and localize these objects within the received image 106. In certain embodiments, the first machine learning model 102 may also be capable of classifying the detected objects into predefined categories. In certain implementations, different types of objects 108 may be identified using different specialized machine learning models. For example, the computing device 102, 104 may be configured to distinguish between various types of objects 108 and select a corresponding model (e.g., the first machine learning model 112) to identify the specific object 108. This approach allows for more accurate and efficient object detection by leveraging models trained on specific object categories. For example, a second machine learning model 114 may be used as a preliminary classifier to determine that an image 106 depicts one or more clothing items. Based on this classification, the computing device 102, 104 may then select the first machine learning model 112, which is specifically trained to detect and identify different types of clothing items, to analyze the image 106 in detail. The first machine learning model 112 may then determine that the image 106 depicts a shirt (or a particular type of shirt). In certain implementations, image 106 processing and object 108 detection may be performed either on the first computing device 102 (e.g., a user device) or a second computing device 104 (e.g., a server device). When performed on a user's device, the device may employ lightweight, optimized models to ensure quick response times. In such cases, to improve efficiency and accuracy, the device 102 may crop the image 106 to focus on the detected object 108 before further processing or transmitting to the server. For example, if a shirt is detected in a larger scene, the device may crop the image to include only the shirt, reducing data transfer requirements and focusing subsequent analysis on the relevant portion of the image. This approach can significantly reduce processing time and bandwidth usage, especially in scenarios with limited network connectivity or when dealing with high-resolution images.

The second computing device 104 may be configured to determine a corresponding object record 120 for the object 108. In certain implementations, the corresponding object record 120 may be determined within a database 116 storing a plurality of object records. In certain implementations, the database 116 may be structured to efficiently store and retrieve information about various objects. Each object record 120 in the database 116 may contain multiple fields to comprehensively describe the object and its associated digital content. These fields may include a unique object ID (a distinct identifier for each object), object type (such as poster, clothing item, book cover, or 3D object), visual characteristics (descriptors of the object's appearance, including color schemes and patterns), textual information (any text present on the object), dimensional data (physical measurements or 3D model information for validation), relevant keywords or tags (for improved searchability), and references to associated digital content 126 (links or identifiers for accessible content upon recognition). Additionally, the database 116 may store information about the content provider (details of the entity supplying the digital content 126), access rights (specifying who can access the content and under what conditions), and timestamps (recording when the record was created or last updated). In certain embodiments, the database 116 may be optimized for fast querying and may support various indexing strategies to enhance search performance across these fields, enabling rapid and accurate matching of detected objects with their corresponding records.

In certain implementations, the database 116 may be structured to accommodate various content ownership and distribution models. In some embodiments, the database 116 may be specific to a particular provider of content, such as a single media company or brand, containing only objects and associated digital content from that provider. This approach may allow for tighter control over content and streamlined management of digital rights. Alternatively, the database 116 may be designed to incorporate and authenticate access to content from multiple parties. In such implementations, the database 116 may include a robust authentication and rights management system to ensure that each content provider maintains control over their specific digital assets. The system may implement secure application programming interface (API) integrations with various content providers, allowing for real-time verification of access rights and seamless retrieval of digital content from diverse sources. This flexibility enables the platform to support a wide range of use cases, from brand-specific promotional campaigns to comprehensive multi-media libraries accessible through a single object recognition system.

In certain implementations, new object records 120 may be added to the database 116 through a structured process designed to maintain data integrity and prevent duplication. Content providers or authorized users may submit new object records via a secure interface, which may include a web portal or API. When adding a new object record, users may be required to provide essential information such as the object type, high-quality images of the object from multiple angles, textual information present on the object, and physical dimensions. Additionally, users may input metadata including keywords, associated digital content links, and access rights information.

In certain implementations, the system 100 may employ a multi-step verification process to ensure the quality and uniqueness of new entries. This process may include automated image analysis using machine learning algorithms to extract visual features, creating a unique visual signature for a newly-added object. Any text associated with the newly-added object may be analyzed and indexed for improved searchability and matching. Before adding a new record, the system 100 may perform one or more deduplication checks to prevent redundant entries. Such checks may involve comparing the extracted visual features against existing records using similarity metrics, analyzing textual information for close matches, checking for similar combinations of metadata, and the like. To account for slight variations in user-submitted data, the system 100 may employ fuzzy matching techniques to identify potential duplicates that might not be exact matches. In cases where potential duplicates are identified, or when the system's confidence in uniqueness is below a certain threshold, the entry may be flagged for manual review by a content moderation team. For objects that may have multiple legitimate versions, such as special editions of a book cover, the system may implement a versioning mechanism to link related objects while maintaining distinct records. In the event that a potential duplicate is identified after addition, the system 100 may have a defined process for resolving conflicts, which could involve notifying the original content providers and facilitating a resolution.

In certain implementations, determining a corresponding object record 120 may include extracting one or more keywords 122 from an input (e.g., the image 106) that correspond to the object 108, determining the corresponding object record 120 based on the one or more keywords 122 including at least one matching keyword from the corresponding object record 120. This process may involve several steps to accurately extract and match keywords from the image to the database records. First, the computing device 102, 104 may employ optical character recognition (OCR) technology to identify and extract any text visible on the object 108 within the image 106. This extracted text may then be processed using natural language processing (NLP) techniques to identify key terms, phrases, or identifiers that are likely to be significant for matching purposes. For example, consider an image 106 of a movie poster for a film titled “Galactic Odyssey”. The OCR system may extract text from the poster, including the title, tagline, actor names, and release date. The NLP processing might identify “Galactic Odyssey” as the primary keyword, along with secondary keywords like the lead actor's name “John Spaceman” and the tagline “Journey Beyond the Stars”. These extracted keywords 122 are then used to query the database 116. The computing device 102, 104 may use a weighted matching algorithm that prioritizes certain types of keywords. In this example, the movie title “Galactic Odyssey” could be given the highest weight, followed by the actor name and other extracted information. The database query may return potential matches based on these keywords. A corresponding object record 120 may be determined when there is a strong match between the extracted keywords and the keywords stored in the database record. Continuing the example, a database record for the “Galactic Odyssey” movie poster containing matching keywords for the title, actor, and tagline would be identified as the corresponding object record 120. In cases where multiple potential matches are found, the computing device 102, 104 may employ additional matching criteria, such as visual similarity or dimensional data, to determine the most accurate corresponding object record 120.

In certain implementations, the computing device 102, 104 may employ an adjustable image matching threshold based on the extracted keywords 122, which may allow for more flexible and context-aware object recognition. For instance, if highly specific or unique keywords are extracted from the image 106 (such as a distinctive product name, product logo, brand name, brand logo, band name, band logo, slogan, and the like) the system may lower the threshold for visual similarity matching. This is because the presence of such specific keywords increases the likelihood of a correct match, even if the visual match is not perfect due to factors like lighting or angle. Conversely, if only generic keywords are extracted, the system may increase the threshold for visual similarity matching to ensure accuracy. For example, if an image of a t-shirt only yields generic keywords like “cotton” and “blue,” the computing device 102, 104 may require a higher degree of visual similarity to confidently determine a match. The adjustable threshold may also take into account the number of extracted keywords. A larger number of matching keywords may allow for a lower visual similarity threshold, while fewer matching keywords would necessitate a stricter visual match. This dynamic thresholding helps balance the reliance on textual and visual information, optimizing the system's ability to accurately identify objects across various scenarios and image qualities.

In certain implementations, the corresponding object record 120 may include one or more images 124 of a verified object 108. In such instances, determining the corresponding object record 120 comprises determining that the object 108 within the image 106 matches the verified object 108. The computing device 102, 104 may be configured to utilize one or more advanced image recognition and comparison techniques to ensure accurate matching. For example, the computing device 102, 104 may employ a multi-step approach involving feature extraction, feature matching, geometric verification, similarity scoring, and threshold application. Initially, the computing device 102, 104 may extract distinctive visual features from both the input image 106 and the verified object images 124 stored in the database, potentially utilizing algorithms such as Scale-Invariant Feature Transform (SIFT) or Speeded Up Robust Features (SURF). The extracted features may then be compared using various matching algorithms to identify corresponding features between the images. To account for different perspectives or partial occlusions, the system may perform geometric verification, ensuring that the spatial relationships between matched features are consistent. Based on the number and quality of matched features, as well as the geometric consistency, a similarity score may be computed for each potential match. This calculated similarity score may then be compared against a predefined threshold to determine if the match is sufficiently strong to be considered valid. For example, if a user captures an image of a limited edition sneaker, the computing device 102, 104 may extract visual features such as the unique pattern on the shoe's upper, the shape of the sole, and any distinctive logos or markings. These features may be compared against a database of verified object images containing various sneaker models, including multiple angles of the limited edition model in question. If a high number of matching features is found with a particular set of verified images, and the geometric verification confirms consistency, the computing device 102, 104 may calculate a similarity score. Should this score exceed the predefined threshold, the computing device 102, 104 may determine that the object in the user's image matches the verified object, thereby identifying the corresponding object record 120. Such implementations may allow for robust object recognition even when the input image varies in terms of lighting, angle, or background from the verified images, providing reliable access to the associated digital content.

In certain implementations, determining the corresponding object record 120 includes detecting a visual data representation and determining the corresponding object record 120 based on the visual data representation. A visual data representation may include various techniques or representations that visually encode digital information, such as QR codes, barcodes, data matrices, digital watermarks, and the like. Visual data representations may be overtly visible or may not be visible (such as by embedding the representation within an object's design). To determine the corresponding object record 120 based on the visual data representation, the computing device 102, 104 may employ computer vision models and techniques to detect and isolate the visual data representation within the image 106. Once isolated, specialized decoding algorithms may be applied to extract the encoded information. For QR codes or similar matrix barcodes, this may involve analyzing the pattern of black and white squares to retrieve the stored data. For digital watermarks, more sophisticated signal processing techniques (such as machine learning techniques) may be required to extract the hidden information. The extracted data may contain various types of information useful for identifying the corresponding object record 120. For example, the extracted data may include a unique identifier that directly corresponds to a database entry, eliminating the need for further image analysis. Alternatively, the visual data representation might encode metadata about the object, such as its type, manufacture date, or associated campaign, which can be used to narrow down the search within the database. In some implementations, the encoded data might include a URL or API endpoint that the computing device 102, 104 can query to retrieve the full object record or associated digital content. The computing device 102, 104 may also be designed to handle tiered or layered visual data representations, where an initial scan provides basic information, and subsequent, more detailed scans reveal additional data for enhanced interactivity or verification purposes.

In certain implementations, additional detection techniques may be employed to determine corresponding objects 108. Comprehensive image matching of the object may be utilized, where the entire visual appearance of the object may be compared against a database of known objects using advanced computer vision algorithms, which may be particularly effective for objects with distinctive visual features. The computing device 102, 104 may also employ type-specific object detection, where specialized machine learning models may be trained to recognize and classify particular categories of objects, potentially improving accuracy for specific item types. In some implementations, the system may be capable of detecting hidden or embedded QR codes that may not be immediately visible to the human eye, which might be printed using specialized inks or embedded within the object's design. Multi-modal fusion techniques may be employed, potentially combining data from various detection methods to improve accuracy by synthesizing results from multiple sources. The system may also utilize contextual analysis, where it may consider the environment or setting in which the object appears, potentially analyzing other objects in the image or considering metadata such as location or time. In certain cases, the computing device 102, 104 may incorporate user interaction for disambiguation, such as by presenting the user with a set of potential matches and allowing them to select the correct match, which may improve the system's accuracy and learning capabilities over time.

In certain implementations, when multiple objects 108 are detected within a single image 106, the computing device 102, 104 may be configured to process each object independently. For example, the process to determine corresponding object records 120 may be repeated for each of the multiple objects 108 individually. For example, if an image 106 captures a person wearing a promotional t-shirt while holding a movie poster, the computing device 102, 104 may first detect both objects separately and may then proceed to match the t-shirt design against the database of clothing items, while simultaneously matching the movie poster against a database of film-related promotional materials. This parallel processing approach may allow for efficient handling of complex scenes and might enable the system to provide access to multiple pieces of digital content 126 related to different objects within the same image.

In certain implementations, further verification may be needed to ensure the authenticity of the detected object 108. This additional step may be particularly crucial in scenarios where counterfeit items may potentially compromise the integrity of the system or the value of the associated digital content. For instance, in cases involving high-value collectibles or branded merchandise, the computing device 102, 104 may employ advanced authentication techniques to distinguish genuine items from potential counterfeits. These techniques may include analyzing minute details of the object's construction, verifying specific security features, or cross-referencing with secure databases of authenticated items. In some implementations, the computing device 102, 104 may also prompt the user to provide additional information or capture supplementary images to aid in the verification process. This multi-layered approach to authentication may help maintain the reliability and trustworthiness of the object recognition system, particularly in applications where access to valuable or sensitive digital content may be contingent upon the genuineness of the physical object.

As another example, in certain implementations, the computing device 102, 104 may be configured to determine one or more object characteristics 110 of the object 108 and determine that the corresponding object record 120 was correctly identified based on the one or more object characteristics 110. In certain implementations, object characteristics 110 may refer to various measurable or observable properties of the object 108 that can be used for identification and verification. These characteristics may include, but are not limited to, physical dimensions (e.g., height, width, depth), shape, color, texture, material composition, weight, or any other features that can assist in uniquely identifying the object. The object characteristics 110 may be derived from various input modalities, including visual features from images, acoustic features from audio inputs, haptic patterns from tactile inputs, or properties of virtual objects within a virtual environment. In certain implementations, determining one or more object characteristics 110 of the object 108 may involve utilizing various techniques to estimate or measure the size, shape, or proportions of the detected object within the image 106. The computing device 102, 104 may employ computer vision algorithms that analyze the object in relation to known reference points or markers within the image, and/or may use depth sensing technology if available on the capturing device. Furthermore, the system may incorporate registration data of the item or owner/user/purchaser. This registration data may include unique identifiers associated with the object 108, such as serial numbers, RFID tags, or user credentials, and may link to ownership records or purchase history.

Once the object characteristics 110 are determined, the computing device 102, 104 may compare these measurements against the dimensional data stored in the corresponding object record 120 to verify the accuracy of the match. For example, if the object 108 is a limited edition action figure, the system may analyze the image 106 to estimate the height, width, and depth of the figure. These estimated dimensions may then be compared to the known dimensions stored in the database for that specific action figure model. If the estimated dimensions fall within an acceptable margin of error from the stored values, it may provide additional confidence that the corresponding object record 120 has been correctly determined. In cases where the estimated dimensions differ significantly from the expected values, the computing device 102, 104 may flag the match for further review or prompt the user for additional information or images to resolve the discrepancy. This dimensional verification process may be particularly useful in distinguishing between similar objects of different sizes, such as standard and miniature versions of the same product, or in detecting potential counterfeit items that may not adhere to the exact specifications of the genuine article. By incorporating this additional layer of verification, the system may enhance its ability to accurately identify and authenticate objects, thereby improving the overall reliability of the digital content access mechanism.

In certain implementations, additional techniques may be employed for verifying and validating corresponding objects 108. The computing device 102, 104 may analyze the material composition of the object using spectral imaging or other advanced sensing technologies, potentially detecting specific materials or fabric types that may be cross-referenced with expected composition data. Dynamic feature verification may be utilized, where the user may be prompted to interact with the object in a specific way, allowing the system to analyze the object's behavior or appearance changes during this interaction. In some implementations, blockchain technology may be incorporated for object verification, where each authentic object may be associated with a unique blockchain entry that may be used to validate the object's provenance and authenticity in real-time. Biometric authentication may be integrated into the verification process for certain types of objects, potentially using facial recognition or fingerprint scanning to ensure that the user attempting to access the digital content may be the authorized owner of a custom item. The computing device 102, 104 may also employ crowd-sourced verification techniques, possibly presenting the object's details to a network of trusted human verifiers who can provide additional authentication in cases where the system's confidence may be below a certain threshold. Lastly, AI-driven anomaly detection algorithms may be utilized, which may be trained on large datasets of genuine and counterfeit objects, potentially identifying subtle inconsistencies or anomalies that may not be apparent through other verification methods.

The computing device 102, 104 may be configured to provide access to one or more pieces of digital content 126 in response to determining the corresponding object record 120. In certain implementations, the digital content 126 provided in response to determining the corresponding object record 120 may encompass a wide variety of media types and interactive experiences. The digital content 126 may include high-resolution images or 3D models of the object, which may allow users to examine intricate details or view the object from multiple angles. In some cases, the digital content 126 may comprise video content, such as behind-the-scenes footage of a product's creation, interviews with designers, or promotional trailers for associated media. The digital content 126 may also include audio content, which may consist of music tracks, podcast episodes, or audio commentaries related to the object. For literary works, the digital content 126 may include e-book versions, audiobook samples, or exclusive author interviews. In the case of collectibles or memorabilia, the digital content 126 may offer detailed historical information, authenticity certificates, or virtual exhibitions showcasing related items. The digital content 126 may further include interactive content, which may comprise augmented reality (AR) experiences that overlay digital information onto the physical object when viewed through a compatible device. The digital content 126 may also offer virtual reality (VR) content, which may allow users to immerse themselves in virtual environments related to the object's theme or origin. For gaming-related objects, the digital content 126 might include downloadable game content, exclusive character skins, or access to special in-game events. The digital content 126 may provide educational content for certain objects, which may include step-by-step tutorials, online courses, or interactive learning modules related to the object's function or history. In some implementations, the digital content 126 may include social features, such as access to exclusive online communities, forums, or social media groups related to the object. The digital content 126 may also offer live content, which may include access to live-streamed events, Q&A sessions with creators, or real-time product demonstrations. Additionally, the digital content 126 may include personalized or customizable elements, which may allow users to create custom designs based on the original object, or access tools for 3D printing replicas or modifications of the object.

In certain implementations, providing access to the one or more pieces of digital content 126 comprises streaming multimedia content to the computing device. Alternatively, the system may allow users to download the digital content 126, potentially with certain restrictions to prevent unauthorized distribution. For example, the system may permit a limited number of downloads or set time-based access windows (e.g., 24 or 48 hours) during which the content can be accessed or downloaded. For items like t-shirts or posters that may wear out over time, a combination of unlimited streaming and limited downloads can be implemented—offering users continuous access through streaming while restricting the number of full downloads to, for instance, two or three upon initial purchase. In certain implementations, the digital content 126 may be stored on the same computing device or server that performed the verification of the object 108. In other implementations, the digital content 126 may be stored on a separate server or distributed across multiple servers. When the digital content 126 is stored on a third-party server, the system may employ various methods to validate and provide secure access to the content. For instance, the system may utilize secure token-based authentication, where a temporary access token may be generated upon successful object verification. This token may be sent to the third-party server to authorize content access. In some implementations, the system may employ OAuth 2.0 or similar protocols for secure authorization. The system may also use encrypted communication channels, such as HTTPS, to ensure that all data transfers between the user's device, the verification server, and the content server remain secure. Additionally, the system may implement IP whitelisting or geo-fencing techniques to restrict access to authorized networks or geographical regions. In certain cases, the system may use a federated content delivery network, where content access may be managed through a central authorization server while the actual content may be distributed across multiple secure locations. This approach may help balance load and improve access speeds while maintaining centralized control over content distribution. The system may also employ real-time access validation, where the user's rights to access the content may be continuously verified throughout the session. This may help prevent unauthorized sharing or access to the content after initial authorization.

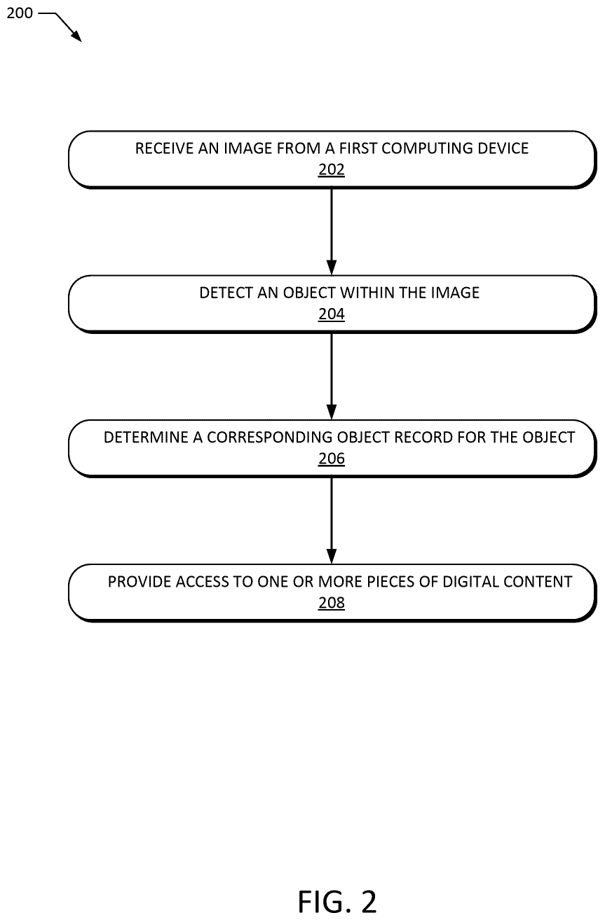

FIG. 2 illustrates a method 200 for object identification and verification for digital content access control according to one aspect of the present disclosure. The method 200 may be implemented on a computer system, such as the system 100. For example, the method 200 may be implemented by the computing device 102 and/or the computing device 104. The method 200 may also be implemented by a set of instructions stored on a computer readable medium that, when executed by a processor, cause the computing device to perform the method 200. Although the examples below are described with reference to the flowchart illustrated in FIG. 2, many other methods of performing the acts associated with FIG. 2 may be used. For example, the order of some of the blocks may be changed, certain blocks may be combined with other blocks, one or more of the blocks may be repeated, and some of the blocks may be optional.

The method 200 includes receiving an image from a first computing device (block 202). For example, the second computing device 104 may receive an image 106 from a first computing device 102.

The method 200 includes detecting an object within the image (block 204). For example, the second computing device 104 may detect an object 108 within the image 106. In certain implementations, the object 108 may be detected using a first machine learning model 112.

The method 200 includes determining a corresponding object record for the object (block 206). For example, the second computing device 104 may determine a corresponding object record 120 for the object 108. In certain implementations, determining a corresponding object record includes extracting one or more keywords from the image that correspond to the object and determining the corresponding object record based on the one or more keywords including at least one matching keyword from the corresponding object record. In certain implementations, the corresponding object record may include one or more images of a verified object. In such instances, determining the corresponding object record may include determining that the object in within the image matches the verified object. In certain implementations, determining the corresponding object record may include detecting a visual data representation and determining the corresponding object record based on the visual data representation.

The method 200 includes providing access to one or more pieces of digital content in response to determining the corresponding object record (block 208). For example, the second computing device 104 may provide access to one or more pieces of digital content 126 in response to determining the corresponding object record 120. In certain implementations, providing access to the one or more pieces of digital content comprises streaming multimedia content to the first computing device 102.

In certain implementations, the method 200 further includes determining one or more physical dimensions of the object and determining that the corresponding object record was correctly determined based on the one or more physical dimensions.

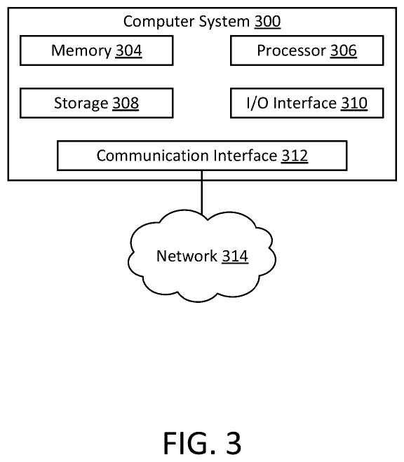

FIG. 3 illustrates an example computer system 300 that may be utilized to implement one or more of the devices and/or components discussed herein, such as the computing device 102 and computing device 104. In particular embodiments, one or more computer systems 300 perform one or more steps of one or more methods described or illustrated herein. In particular embodiments, one or more computer systems 300 provide the functionalities described or illustrated herein. In particular embodiments, software running on one or more computer systems 300 performs one or more steps of one or more methods described or illustrated herein or provides the functionalities described or illustrated herein. Particular embodiments include one or more portions of one or more computer systems 300. Herein, a reference to a computer system may encompass a computing device, and vice versa, where appropriate. Moreover, a reference to a computer system may encompass one or more computer systems, where appropriate.

This disclosure contemplates any suitable number of computer systems 300. This disclosure contemplates the computer system 300 taking any suitable physical form. As example and not by way of limitation, the computer system 300 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, the computer system 300 may include one or more computer systems 300; be unitary or distributed; span multiple locations; span multiple machines; span multiple data centers; or reside in a cloud, which may include one or more cloud components in one or more networks. Where appropriate, one or more computer systems 300 may perform without substantial spatial or temporal limitation one or more steps of one or more methods described or illustrated herein. As an example and not by way of limitation, one or more computer systems 300 may perform in real time or in batch mode one or more steps of one or more methods described or illustrated herein. One or more computer systems 300 may perform at different times or at different locations one or more steps of one or more methods described or illustrated herein, where appropriate.

In particular embodiments, computer system 300 includes a processor 306, memory 304, storage 308, an input/output (I/O) interface 310, and a communication interface 312. Although this disclosure describes and illustrates a particular computer system having a particular number of particular components in a particular arrangement, this disclosure contemplates any suitable computer system having any suitable number of any suitable components in any suitable arrangement.

In particular embodiments, the processor 306 includes hardware for executing instructions, such as those making up a computer program. As an example and not by way of limitation, to execute instructions, the processor 306 may retrieve (or fetch) the instructions from an internal register, an internal cache, memory 304, or storage 308; decode and execute the instructions; and then write one or more results to an internal register, internal cache, memory 304, or storage 308. In particular embodiments, the processor 306 may include one or more internal caches for data, instructions, or addresses. This disclosure contemplates the processor 306 including any suitable number of any suitable internal caches, where appropriate. As an example and not by way of limitation, the processor 306 may include one or more instruction caches, one or more data caches, and one or more translation lookaside buffers (TLBs). Instructions in the instruction caches may be copies of instructions in memory 304 or storage 308, and the instruction caches may speed up retrieval of those instructions by the processor 306. Data in the data caches may be copies of data in memory 304 or storage 308 that are to be operated on by computer instructions; the results of previous instructions executed by the processor 306 that are accessible to subsequent instructions or for writing to memory 304 or storage 308; or any other suitable data. The data caches may speed up read or write operations by the processor 306. The TLBs may speed up virtual-address translation for the processor 306. In particular embodiments, processor 306 may include one or more internal registers for data, instructions, or addresses. This disclosure contemplates the processor 306 including any suitable number of any suitable internal registers, where appropriate. Where appropriate, the processor 306 may include one or more arithmetic logic units (ALUs), be a multi-core processor, or include one or more processors 306. Although this disclosure describes and illustrates a particular processor, this disclosure contemplates any suitable processor.

In particular embodiments, the memory 304 includes main memory for storing instructions for the processor 306 to execute or data for processor 306 to operate on. As an example, and not by way of limitation, computer system 300 may load instructions from storage 308 or another source (such as another computer system 300) to the memory 304. The processor 306 may then load the instructions from the memory 304 to an internal register or internal cache. To execute the instructions, the processor 306 may retrieve the instructions from the internal register or internal cache and decode them. During or after execution of the instructions, the processor 306 may write one or more results (which may be intermediate or final results) to the internal register or internal cache. The processor 306 may then write one or more of those results to the memory 304. In particular embodiments, the processor 306 executes only instructions in one or more internal registers or internal caches or in memory 304 (as opposed to storage 308 or elsewhere) and operates only on data in one or more internal registers or internal caches or in memory 304 (as opposed to storage 308 or elsewhere). One or more memory buses (which may each include an address bus and a data bus) may couple the processor 306 to the memory 304. The bus may include one or more memory buses, as described in further detail below. In particular embodiments, one or more memory management units (MMUs) reside between the processor 306 and memory 304 and facilitate accesses to the memory 304 requested by the processor 306. In particular embodiments, the memory 304 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 304 may include one or more memories 304, where appropriate. Although this disclosure describes and illustrates particular memory implementations, this disclosure contemplates any suitable memory implementation.

In particular embodiments, the storage 308 includes mass storage for data or instructions. As an example and not by way of limitation, the storage 308 may include a hard disk drive (HDD), a floppy disk drive, flash memory, an optical disc, a magneto-optical disc, magnetic tape, or a Universal Serial Bus (USB) drive or a combination of two or more of these. The storage 308 may include removable or non-removable (or fixed) media, where appropriate. The storage 308 may be internal or external to computer system 300, where appropriate. In particular embodiments, the storage 308 is non-volatile, solid-state memory. In particular embodiments, the storage 308 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 308 taking any suitable physical form. The storage 308 may include one or more storage control units facilitating communication between processor 306 and storage 308, where appropriate. Where appropriate, the storage 308 may include one or more storages 308. Although this disclosure describes and illustrates particular storage, this disclosure contemplates any suitable storage.

In particular embodiments, the I/O Interface 310 includes hardware, software, or both, providing one or more interfaces for communication between computer system 300 and one or more I/O devices. The computer system 300 may include one or more of these I/O devices, where appropriate. One or more of these I/O devices may enable communication between a person (i.e., a user) and computer system 300. As an example and not by way of limitation, an I/O device may include a keyboard, keypad, microphone, monitor, screen, display panel, mouse, printer, scanner, speaker, still camera, stylus, tablet, touch screen, trackball, video camera, another suitable I/O device or a combination of two or more of these. An I/O device may include one or more sensors. Where appropriate, the I/O Interface 310 may include one or more device or software drivers enabling processor 306 to drive one or more of these I/O devices. The I/O interface 310 may include one or more I/O interfaces 310, where appropriate. Although this disclosure describes and illustrates a particular I/O interface, this disclosure contemplates any suitable I/O interface or combination of I/O interfaces.

In particular embodiments, communication interface 312 includes hardware, software, or both providing one or more interfaces for communication (such as, for example, packet-based communication) between computer system 300 and one or more other computer systems 300 or one or more networks 314. As an example and not by way of limitation, communication interface 312 may include a network interface controller (NIC) or network adapter for communicating with an Ethernet or any other wire-based network or a wireless NIC (WNIC) or wireless adapter for communicating with a wireless network, such as a Wi-Fi network. This disclosure contemplates any suitable network 314 and any suitable communication interface 312 for the network 314. As an example and not by way of limitation, the network 314 may include one or more of an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 300 may communicate with a wireless PAN (WPAN) (such as, for example, a Bluetooth® WPAN), a WI-FI network, a WI-MAX network, a cellular telephone network (such as, for example, a Global System for Mobile Communications (GSM) network), or any other suitable wireless network or a combination of two or more of these. Computer system 300 may include any suitable communication interface 312 for any of these networks, where appropriate. Communication interface 312 may include one or more communication interfaces 312, where appropriate. Although this disclosure describes and illustrates a particular communication interface implementations, this disclosure contemplates any suitable communication interface implementation.

The computer system 302 may also include a bus. The bus may include hardware, software, or both and may communicatively couple the components of the computer system 300 to each other. As an example and not by way of limitation, the bus may include an Accelerated Graphics Port (AGP) or any other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-PIN-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local bus (VLB), or another suitable bus or a combination of two or more of these buses. The bus may include one or more buses, where appropriate. Although this disclosure describes and illustrates a particular bus, this disclosure contemplates any suitable bus or interconnect.

Herein, a computer-readable non-transitory storage medium or media may include one or more semiconductor-based or other types of integrated circuits (ICs) (e.g., field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

All of the disclosed methods and procedures described in this disclosure can be implemented using one or more computer programs or components. These components may be provided as a series of computer instructions on any conventional computer readable medium or machine readable medium, including volatile and non-volatile memory, such as RAM, ROM, flash memory, magnetic or optical disks, optical memory, or other storage media. The instructions may be provided as software or firmware, and may be implemented in whole or in part in hardware components such as ASICs, FPGAs, DSPs, or any other similar devices. The instructions may be configured to be executed by one or more processors, which when executing the series of computer instructions, performs or facilitates the performance of all or part of the disclosed methods and procedures.

It should be understood that various changes and modifications to the examples described here will be apparent to those skilled in the art. Such changes and modifications can be made without departing from the spirit and scope of the present subject matter and without diminishing its intended advantages. It is therefore intended that such changes and modifications be covered by the appended claims.

1. A method comprising:
receiving an image from a first computing device;
detecting an object within the image;
determining a corresponding object record for the object; and
providing access to one or more pieces of digital content in response to determining the corresponding object record.

2. The method of claim 1, wherein the object is detected using a first machine learning model.

3. The method of claim 1, wherein the corresponding object record is determined within a database storing a plurality of object records.

4. The method of claim 1, wherein determining a corresponding object record comprises:
extracting one or more keywords from the image that correspond to the object; and
determining the corresponding object record based on the one or more keywords including at least one matching keyword from the corresponding object record.

5. The method of claim 1, wherein the corresponding object record includes one or more images of a verified object, and wherein determining the corresponding object record comprises determining that the object within the image matches the verified object.

6. The method of claim 1, wherein determining the corresponding object record comprises:
detecting a visual data representation; and
determining the corresponding object record based on the visual data representation.

7. The method of claim 1, further comprising:
determining one or more object characteristics of the object; and
determining that the corresponding object record was correctly determined based on the one or more object characteristics.

8. The method of claim 1, wherein providing access to the one or more pieces of digital content comprises streaming multimedia content to the computing device.

9. The method of claim 1, wherein receiving an image from a first computing device comprises receiving the image from a virtual reality (VR) headset operating in an augmented reality (AR) or VR setting.

10. A system comprising:
a processor; and
a memory storing instructions which, when executed by the processor, cause the processor to perform operations including:
receiving an image from a first computing device;
detecting an object within the image;
determining a corresponding object record for the object; and
providing access to one or more pieces of digital content in response to determining the corresponding object record.

11. The system of claim 10, wherein the operations further include detecting the object using a first machine learning model.

12. The system of claim 10, wherein the corresponding object record is determined within a database storing a plurality of object records.

13. The system of claim 10, wherein determining a corresponding object record comprises:
extracting one or more keywords from the image that correspond to the object; and
determining the corresponding object record based on the one or more keywords including at least one matching keyword from the corresponding object record.

14. The system of claim 10, wherein the corresponding object record includes one or more images of a verified object, and wherein determining the corresponding object record comprises determining that the object within the image matches the verified object.

15. The system of claim 10, wherein determining the corresponding object record comprises:
detecting a visual data representation; and
determining the corresponding object record based on the visual data representation.

16. The system of claim 10, wherein the operations further include:
determining one or more object characteristics of the object; and
determining that the corresponding object record was correctly determined based on the one or more object characteristics.

17. The system of claim 10, wherein providing access to the one or more pieces of digital content comprises streaming multimedia content to the computing device.

18. The system of claim 10, wherein receiving an image from a first computing device comprises receiving the image from a virtual reality (VR) headset operating in an augmented reality (AR) or VR setting.

19. A non-transitory, computer-readable medium storing instructions which, when executed by a processor, cause the processor to perform operations, comprising:
receiving an image from a first computing device;
detecting an object within the image;
determining a corresponding object record for the object; and
providing access to one or more pieces of digital content in response to determining the corresponding object record.

20. The non-transitory, computer-readable medium of claim 19, wherein the corresponding object record includes one or more images of a verified object, and wherein determining the corresponding object record comprises determining that the object within the image matches the verified object.
